(19) United States
(12) Patent Application Publication
(10) Pub. No.: US 2020/0095828 A1
(43) Pub. Date: Mar. 26, 2020

(54) Low-Profile Fly Arm Step Ladder

(71) Applicant: HD Assembly Inc., Brantford (CA)

(72) Inventor: John Boris Deml, Brantford (CA)

(21) Appl. No.: 16/142,318

(22) Filed: Sep. 26, 2018

(51) Int. Cl. E06C 7/48; E06C 7/46; E06C 7/42

(52) U.S. Cl. CPC E06C 7/48; E06C 7/423; E06C 7/46

(57) ABSTRACT

A low-profile fly arm step ladder has a pair of first ladder legs with steps and a pair of second ladder legs. Bracket arrangements are mounted to upper ends of the first ladder legs. Each second ladder leg is mounted in a portion of a respective bracket arrangement. A fly arm assembly is provided that has two ends on one side. Each end is mounted with a portion of the bracket arrangement of a respective first ladder leg. The bracket arrangements permit: (i) the second ladder legs to transition from a storage position abutting the first ladder legs to a step ladder position in which the first and second ladder legs contact the floor; and (ii) the fly arm assembly to extend out into a braced single ladder position in which the first ladder legs contact the floor and the fly arm assembly contacts a surface above the floor.

### FIELD OF THE INVENTION

The invention relates to ladders commonly referred to as step ladders or step stools, and more particularly relates to step ladders.

### BACKGROUND OF THE INVENTION

Step ladders are a popular household convenience. These types of ladders have pairs of legs (at least one with steps or rungs) that open out into a stable A-frame configuration to allow a user to climb up to a higher position with the security of four ladder feet on the floor. Unlike extension ladders, such step ladders do not need to lean on, be attached to, or be hung from another surface. They are thus independently self-supporting.

While this design promotes stability, it has the disadvantage that the step ladder requires a great deal of floor space when deployed. The four feet must all contact the floor when the legs are fully spaced into the ladder's A-frame configuration—forming a wide rectangle on the floor. The user climbs up the steps, and when standing on the top cap of the ladder (if permitted), the user is directly above the center of this notional rectangle.

This is a great working position if the user is doing work directly above the ladder (e.g. changing a lightbulb) and there is plenty of space for the ladder to extend out into this rectangle. However, it is less than ideal if the user is trying to reach a surface opposite the ladder's steps (e.g. reaching a high shelf, placing or removing articles in a raised cupboard, or cleaning a horizontal or vertical surface at a height), or if there is limited floor space.

To reach a surface opposite the ladder's steps, the user must contort his or her body to bend over toward the surface, possibly climbing higher on the ladder than necessary in order to get the user's body closer to the middle of the rectangle, which is ultimately closer to the surface desired. These work positions are at least uncomfortable, and possibly dangerous or unstable for the user. Alternatively, the user might position the ladder sideways to the surface desired, climb up the steps, and torque the user's body 90 degrees to reach toward the desired surface. While placing the user closer the surface, this position is ultimately uncomfortable for the user. It would be desirable to provide the convenience and stability of a step ladder while allowing a lower profile approach to a raised surface.

### SUMMARY OF THE INVENTION

According to a first aspect of the invention, a low-profile fly arm step ladder is provided. The ladder has a pair of first ladder legs with a plurality of steps mounted therebetween. A bracket arrangement is mounted to an upper end of each of the first ladder legs. A pair of second ladder legs is mounted, each in hinged relation with a portion of the bracket arrangement of a corresponding first ladder leg. The ladder also has a fly arm assembly with a configuration with two ends on one side, each such end being mounted with a portion of the bracket arrangement of a respective first ladder leg. The bracket arrangements permit:
the second ladder legs to transition from a storage position abutting the first ladder legs to a step ladder position in which the first and second ladder legs contact the floor; and
the fly arm assembly to extend out into a braced single ladder position in which the first ladder legs contact the floor and the fly arm assembly contacts a surface above the floor.

The fly arm assembly may be applied as an optional accessory to an existing ladder, and may be mounted in various arrangements.

The second ladder legs are preferably in the storage position when the ladder is in the braced single ladder position. This contributes to the “low-profile”. Only one set of feet is on the floor in the braced single ladder position.

While the ladder preferably works with various raised surfaces (desks, tables, etc.), in one preferred embodiment, the surface is a countertop. The distance between the fly arm assembly and the floor in the braced single ladder position is preferably between about 80-100 cm.

Each of the first ladder legs may be joined to a respective one of the second ladder legs by a spreader hinge disposed below the bracket arrangement. The spreader hinge circumscribes the maximum distance between the first ladder legs and the second ladder legs when extended out into the step ladder position.

Preferably, the fly arm assembly has at least one non-marring foot where the fly arm assembly contacts the surface.

In a preferred embodiment, an extension portion of the first ladder legs telescopes outward from each of the first ladder legs above the bracket arrangement. Preferably, a utility shelf is mounted on at least one of the extension portions. For example, the utility shelf may be mounted on the top of the extension portions, spanning therebetween. The utility shelf may include leg rest surfaces on an edge such that a user can rest the user's legs on the leg rest surfaces while standing on an upper step when the extension portions are extended. Due to the telescoping, the leg rest surfaces may be adjusted to a comfortable supporting position for the individual user and task. Preferably, the extension portions are lockable in telescoped position.

Preferably, at least one set of the first and second ladder legs have feet at their lower ends. The feet may be non-skid. Alternatively, or in addition, the feet may be rounded for better contact with the floor over a range of deployment angles.

The first ladder legs may be flared. The second ladder legs may also or in the alternative be flared.

The fly arm assembly may have a generally U-shaped configuration with each end of the U being mounted with the bracket arrangement of a corresponding first ladder leg. By “U-shaped configuration”, it is simply intended that the fly arm assembly has a configuration with a return. Such configurations need not literally be shaped like the letter “U”, but may take other forms instead. For example, V-shaped, circular, oval, semicircular and other shapes may also be considered a “U-shaped configuration” for the present purposes without departing from the intended scope.

The fly arm assembly may be mounted, for example, in hinged relation such that it can transition from a storage position abutting the first ladder legs to its extended position in the braced single ladder position.

Various types of bracket arrangements are possible—including without limitation, one- and two-piece arrangements. For example, each bracket arrangement may comprise two brackets, one holding the respective second ladder leg, and one holding an end of the fly arm assembly. In another example, a single bracket may be provided with two channels, one holding the respective second ladder leg, and one holding an end of the fly arm assembly. In this embodiment, the single ladder leg may be retained in an outer channel of the bracket, while the end of the fly arm assembly is retained in an inner channel of the bracket. By “outer” and “inner”, it is simply intended to mean generally “distal” and “proximate” with respect to the center of the ladder, respectively. No left/right or upper/lower limitation is intended.

According to a second aspect of the invention, a method is provided for assembling a low-profile fly arm step ladder. A bracket arrangement is mounted to the upper end of each of a pair of first ladder legs which have a plurality of steps mounted therebetween. A pair of second ladder legs is mounted in hinged relation with a respective bracket arrangement. A fly arm assembly with two ends on the same side is mounted to this ladder, each end of the fly arm assembly being mounted with a respective bracket arrangement. The bracket arrangements permit:
the second ladder legs to transition from a storage position abutting the first ladder legs to a step ladder position in which the first and second ladder legs contact the floor; and
the fly arm assembly to extend out into a braced single ladder position in which the first ladder legs contact the floor and the fly arm assembly contacts a surface above the floor.

A pair of brackets is also provided for use with this method. A fly arm assembly is also provided for use with this method.

### BRIEF DESCRIPTION OF THE FIGURES

FIG. 1 is a perspective view of the low-profile fly arm step ladder in use in a braced single ladder position with a fly arm assembly extended to rest on a kitchen counter while the user is positioned close to the counter and cabinets for easy access.

FIG. 2 is a perspective view of the ladder in a step ladder position (first and second ladder legs extended and all feet on the floor).

FIG. 3 is a perspective view of the ladder in a storage position (second ladder legs collapsed/folded down and fly arm collapsed/folded down to abut the first ladder legs for compact storage).

FIG. 4 is a detailed view of the fly arm assembly (in extended position) and contact portions.

FIG. 5 is a detailed view of a preferred embodiment of the bracket arrangement as a one-piece bracket with twin channels.

FIG. 6 is a detailed view of a foot.

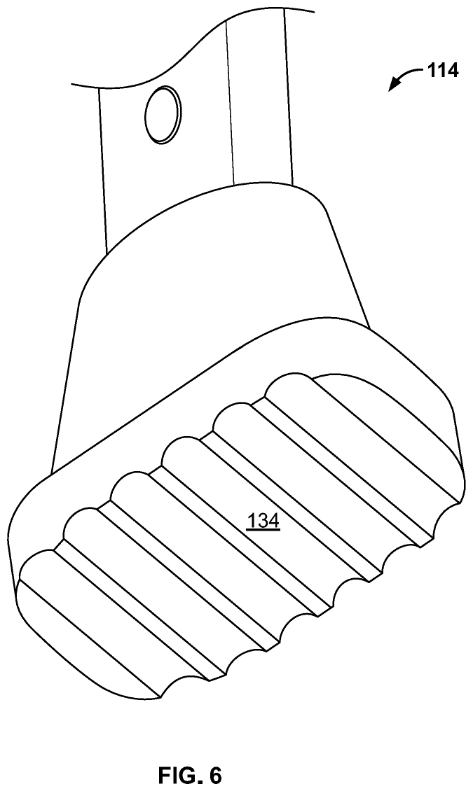

FIG. 7 is a detailed view of the optional utility shelf with leg rest surfaces.

FIG. 8 is a front view of an alternative embodiment with flared first ladder legs.

FIG. 9 is a detailed view of a rounded foot.

### DETAILED DESCRIPTION

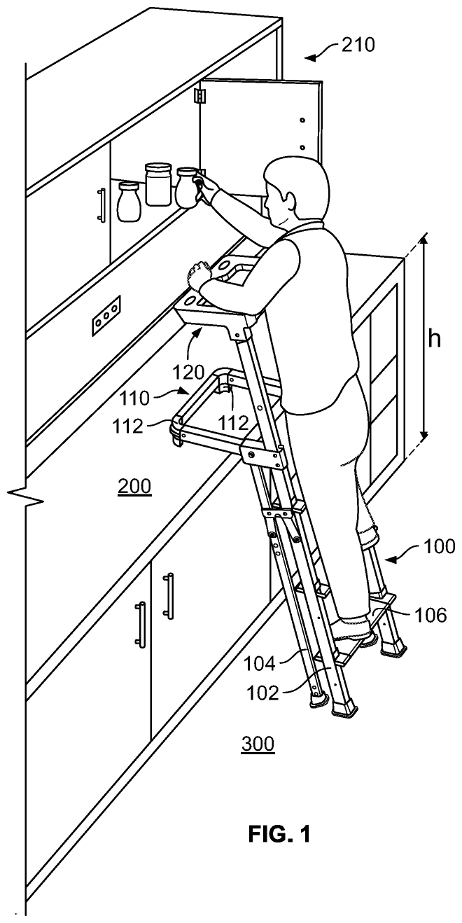

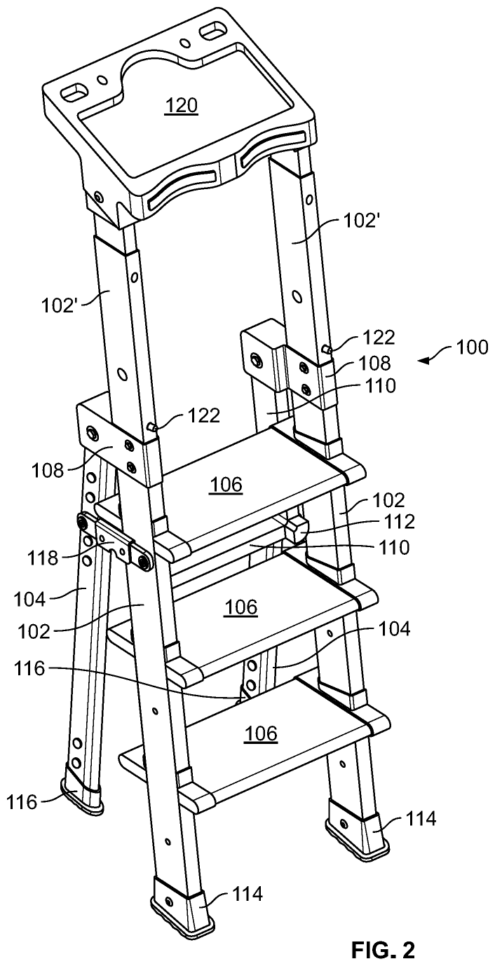

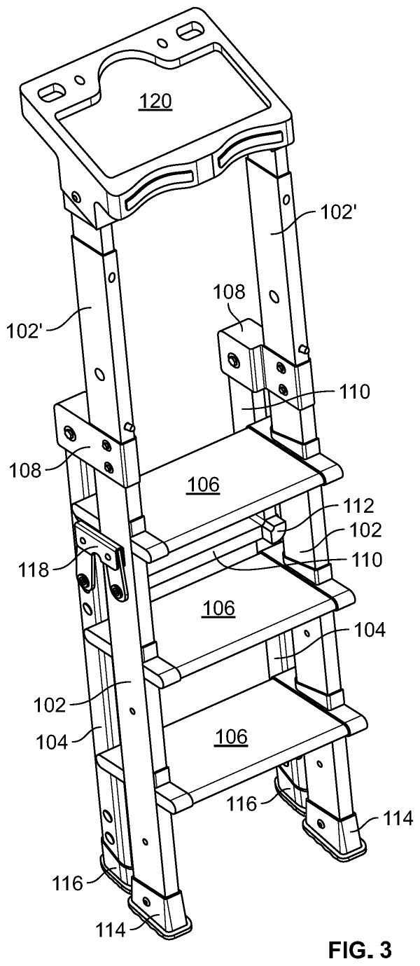

The low-profile fly arm step ladder 100 is a step ladder that has three basic modes:
Storage position (seen in FIG. 3);
Step ladder position (seen in FIG. 2); and
Braced single ladder position (seen in FIG. 1).

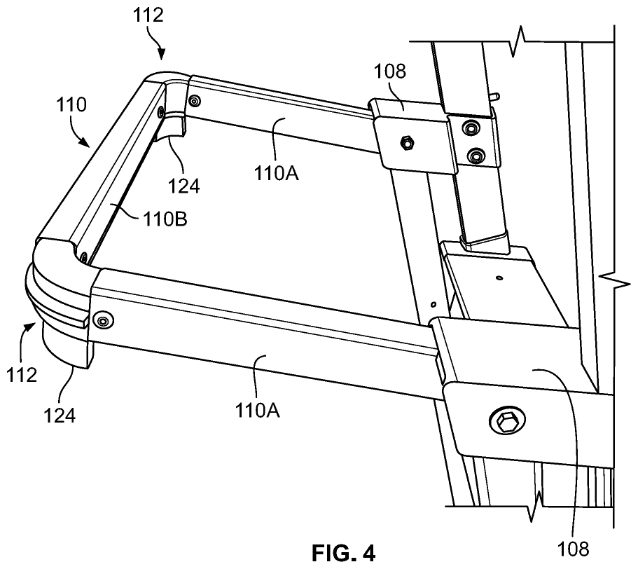

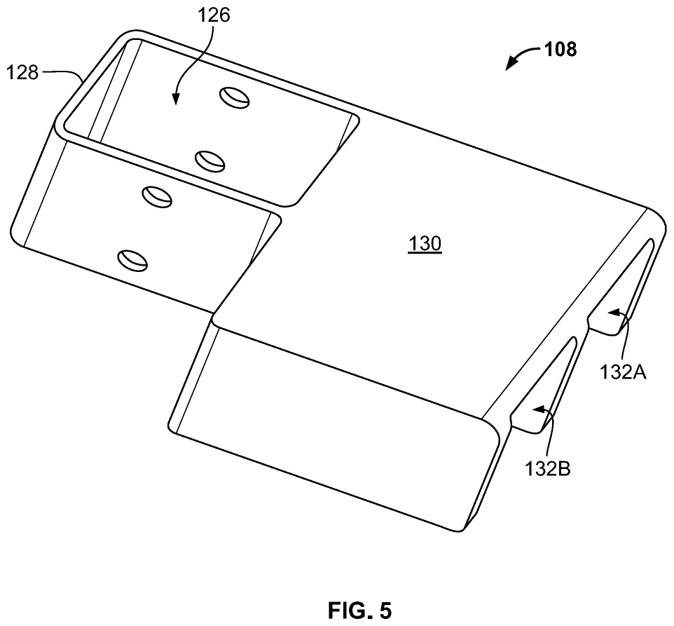

In its basic construction, the ladder 100 has a pair of first ladder legs 102. Steps or rungs 106 are mounted between the first ladder legs 102. A pair of bracket arrangements (in this case, single brackets 108) is provided. An example of the single bracket is shown in FIG. 5. In this embodiment, the opening 126 of extension portion 128 is slid onto the upper ends of the first legs 102 and attached thereto. The brackets also have a bracket body 130 with an inner channel 132B and an outer channel 132A. A pair of second ladder legs 104 is provided. These are mounted in hinged relation in the outer channels 132A of the brackets 108. A fly arm assembly 110 is also provided. In this embodiment, the fly arm assembly has a generally U-shaped configuration (seen in detail in FIG. 4). Each end of the U is mounted in hinged relation in the inner channel 132B of a respective bracket 108. It will be appreciated that multi-bracket arrangements, non-U shaped configurations, and non-hinged arrangements are also possible.

In the storage position, the second ladder legs 104 are folded to lie flat with (and abut) the first ladder legs 102. Where hinged, the fly arm assembly 110 may also be folded down to nest within the second ladder legs 104 and lie flat with the first ladder legs 102.

In the step ladder position, the first and second ladder legs 102, 104 are moved into an A-frame configuration (using the brackets 108 as a hinge). The first legs have optional extension portions 102′ that telescope upward from their bracketed upper ends to provide additional height. The telescoping extension portions may use any known construction with any type of locking mechanism. For example, one type of lock 122 is the spring button type shown in FIG. 2. A utility shelf 120 may be provided at an upper end of the extension portions 102′. A spreader hinge 118 may be provided to join the first and second ladder legs 102, 104 and circumscribe the maximum distance they may be parted in the step ladder position. In the step ladder position, the fly arm assembly 110 is preferably folded down to lie flat with the first ladder legs 102, as shown in FIG. 2.

In the braced single ladder position, as shown in FIG. 1, the first and second ladder legs are folded to lie flat together. However, the fly arm assembly is folded out. The ladder is leaned toward a raised surface (such as counter 200). The feet 114 of the first legs 102 are on the floor 300. The feet 124 of the fly arm contact portions 112 of the fly arm assembly 110 (see more detail in FIG. 4) rest on the raised surface 200. These contact portions 112 are the only part of the ladder that contacts the countertop 200. So, acting together with the feet 114 of the first ladder legs 102, there are four points of planar contact to stabilize the ladder (two at the floor 300 level, and two at counter height h). The fly arm assembly 110 simply folds out and rests (at its contact points) on the surface 200. It does not need to be attached or locked to the surface or in any way adjusted.

The brackets 108 act as the hinge and provide the outer limits for the fly arm assembly in deployed state. The user just needs to position the ladder so that the deployed fly arm assembly is roughly parallel with the surface 200. The ladder preferably accommodates a range of standard counter heights (h)—e.g. about 80-100 cm. The angle of the ladder relative to the folded out fly arm assembly will be approximately 110-120 degrees.

The preferred brackets 108, due to their twin channel 132A, 132B design, also allow the fly arm assembly 110 to be folded (or deployed) independently of the second legs 104. The legs 104 and fly arm assembly 110 do not interfere with one another. In other embodiments, each of these functions may be accomplished with a separate bracket (so that multiple brackets in parallel serve as a “bracket arrangement”).

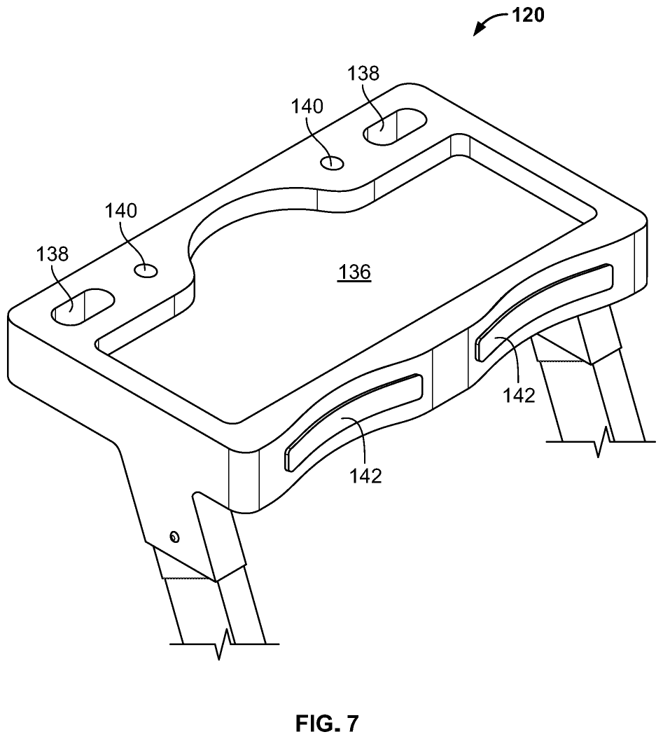

As seen in FIG. 1, in the braced single ladder position, the extension portions of the first legs can also be extended so that the utility shelf 120 is at a useful height for working. The user can lean on the utility shelf, or use it as a staging area for objects being removed from or put into the cupboards 210 above the counter 200. As shown in FIG. 7, the utility shelf 120 can also have a central recess 136 and/or various slots, openings or cavities 138, 140 for attachment of articles or tools (e.g. cleaning products for use at height). Hooks may also be provided (not shown). The openings 138 can also be used for hanging the ladder 100 when stored. The utility shelf 120 may also include leg rest indents or surfaces 142 to allow the user to rest (lean) the user's legs against the utility shelf when the extension portions are fully extended, while the user is standing on the top step.

In the braced single ladder position, the ladder allows close-in and easy access to the counter 200 and cupboard 210 areas while lateral or forward movement of the ladder is prevented by the contact portions 112. Because only one set of ladder legs 102 is deployed (the second set 104 being effectively replaced by the fly arm assembly 110), the ladder does not need the wide rectangle footprint of floorspace that it would otherwise need in a step ladder configuration. It has a low-profile in this sense. The user is front facing to the intended work area and can work in a secure, ergonomic manner.

On the other hand, unlike conventional extension ladders, the ladder does not lean on (or hook onto) the edge of the counter, and accordingly does not have side-to-side shift, or the potential to mar or dent the edge from weight. The force is distributed between the first legs 102 and the contact portions 112. The contact portions 112 are non-marring and anti-skid.

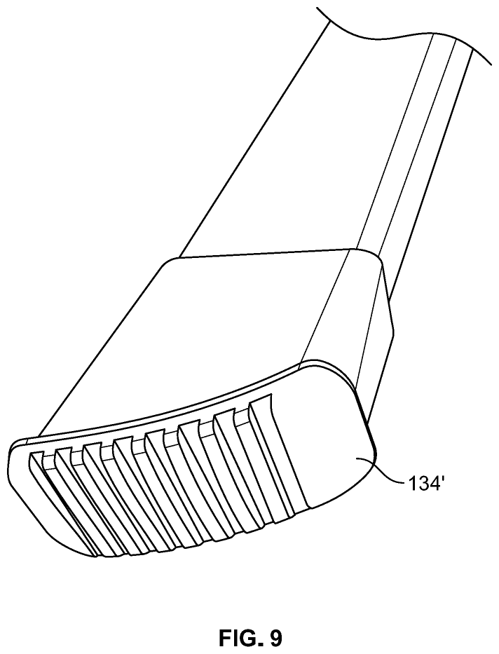

The feet of the ladder 114, 116 are preferably also non-marring and anti-skid. In one embodiment, the feet have rounded or ruggedized bottom surfaces 134 to better contact and grip the floor. An embodiment of the foot with a rounded bottom surface 134′ is shown for example in FIG. 9.

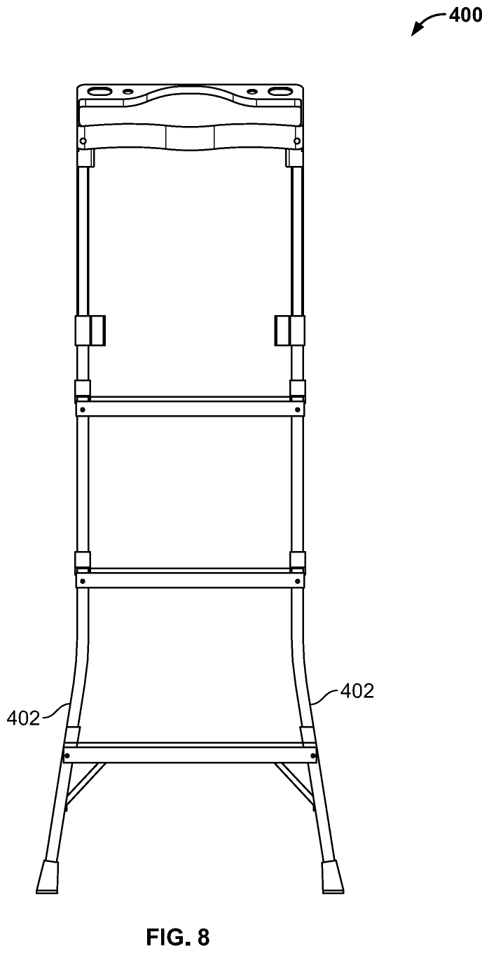

In another embodiment 200, the first ladder legs 402 may be flared, as shown in FIG. 8. This may be preferred or required for certain task or weight bearing requirements.

Various materials may be used for the low-profile fly arm step ladder 100. The legs 102, 104, steps 106, and extension portions 102′, as well as the extension bars 110A and crossbar 1108 of the fly arm assembly 110, are preferably of aluminum (such as 6063-T5, 6061-T5, or 6005-T5). The fly arm contact portions 112 and brackets (or bracket arrangements) 108 are preferably of nylon (such asPA66, PA6 or PA610). The feet 114, 116, step brackets, and utility shelf 120 are preferably of Polypropylene (such as PP-R, PP-H or PP-B). The spreader hinges 118 are preferably of steel (such as A3). It will be appreciated that these are merely examples and not statements of essential requirements.

The ladder is preferably built to conform to ANSI Standards for step ladders.

The scope of the claims should not be limited by the preferred embodiments set forth in the foregoing disclosure, but should be given the broadest purposive construction consistent with the description as a whole and having regard to equivalents set forth or implied.

What is claimed is:

1. A low-profile fly arm step ladder comprising:
a pair of first ladder legs having a plurality of steps mounted therebetween;
a bracket arrangement mounted to an upper end of each of the first ladder legs; a pair of second ladder legs, each mounted in hinged relation with a portion of the bracket arrangement of a corresponding first ladder leg;
a fly arm assembly having a configuration with two ends on one side, each such end being mounted with a portion of the bracket arrangement of a respective first ladder leg;
the bracket arrangements permitting:
the second ladder legs to transition from a storage position abutting the first ladder legs to a step ladder position in which the first and second ladder legs contact the floor; and
the fly arm assembly to extend out into a braced single ladder position in which the first ladder legs contact the floor and the fly arm assembly contacts a surface above the floor.

2. The step ladder of claim 1, wherein the second ladder legs are in the storage position when the ladder is in the braced single ladder position.

3. The step ladder of claim 1, wherein the surface is a countertop.

4. The step ladder of claim 1, wherein the distance between the fly arm assembly and the floor in the braced single ladder position is between about 80-100 cm.

5. The step ladder of claim 1, wherein each of the first ladder legs is joined to a respective one of the second ladder legs by a spreader hinge below the bracket arrangement, the spreader hinge circumscribing the maximum distance between the first ladder legs and the second ladder legs when extended out into the step ladder position.

6. The step ladder of claim 1, wherein the fly arm assembly has at least one non-marring foot where the fly arm assembly contacts the surface.

7. The step ladder of claim 1, further comprising an extension portion telescoping outward from each of the first ladder legs above the bracket arrangement.

8. The step ladder of claim 7, wherein a utility shelf is mounted on at least one of the extension portions.

9. The step ladder of claim 7, wherein a utility shelf is mounted on the top of the extension portions, spanning therebetween.

10. The step ladder of claim 9, wherein the utility shelf includes leg rest surfaces on an edge such that a user can rest the user's legs on the leg rest surfaces while standing on an upper step when the extension portions are extended.

11. The step ladder of claim 7, wherein the extension portions are lockable in telescoped position.

12. The step ladder of claim 1, wherein at least one set of the first and second ladder legs have feet at their lower ends.

13. The step ladder of claim 12, wherein the feet are non-skid.

14. The step ladder of claim 12, wherein the feet are rounded for better contact with the floor over a range of deployment angles.

15. The step ladder of claim 1, wherein the first ladder legs are flared.

16. The step ladder of claim 1, wherein the fly arm assembly has a generally U-shaped configuration with each end of the U being mounted with the bracket arrangement of a corresponding first ladder leg.

17. The step ladder of claim 1, wherein the fly arm assembly is mounted in hinged relation and can transition from a storage position abutting the first ladder legs to its extended position in the braced single ladder position.

18. The step ladder of claim 1, wherein each bracket arrangement comprises two brackets, one holding the respective second ladder leg, and one holding an end of the fly arm assembly.

19. The step ladder of claim 1, wherein each bracket arrangement comprises a single bracket with two channels, one holding the respective second ladder leg, and one holding an end of the fly arm assembly.

20. The step ladder of claim 19, wherein the second ladder leg is retained in an outer channel of the bracket, while the end of the fly arm assembly is retained in an inner channel of the bracket.

21. A method of assembling a low-profile fly arm step ladder comprising:
to a pair of first ladder legs having a plurality of steps mounted therebetween, mounting a bracket arrangement to an upper end of each of the first ladder legs;
mounting a pair of second ladder legs in hinged relation with a respective bracket arrangement;
mounting a fly arm assembly with two ends on the same side to the bracket arrangements, such that each end of the fly arm assembly is mounted with a respective bracket arrangement;
such that each bracket arrangement permits:
the second ladder legs to transition from a storage position abutting the first ladder legs to a step ladder position in which the first and second ladder legs contact the floor; and
the fly arm assembly to extend out into a braced single ladder position in which the first ladder legs contact the floor and the fly arm assembly contacts a surface above the floor.
